(19) United States
(12) Patent Application Publication
(10) Pub. No.: US 2025/0063380 A1
(43) Pub. Date: Feb. 20, 2025

(54) CONFIGURED GRANT RESOURCE HANDLING FOR SMALL DATA TRANSMISSION

(71) Applicant: Nokia Technologies Oy, Espoo (FI)

(72) Inventors: Chunli WU, Beijing (CN); Samuli Heikki TURTINEN, Oulu (FI); Jussi-Pekka KOSKINEN, Oulu (FI); Daniela LASELVA, Aalborg (DK)

(21) Appl. No.: 18/720,971

(22) PCT Filed: Jan. 5, 2022
(86) PCT No.: PCT/CN2022/070376

§ 371 Date: Jun. 17, 2024

(51) Int. Cl. H04W 16/28; H04W 76/20; H04W 80/02

(52) U.S. Cl. CPC H04W 16/28; H04W 76/20; H04W 80/02

(57) ABSTRACT

Embodiments of the present disclosure relate to devices, methods, apparatuses and computer readable storage media of CG resource handling for SDT. The method comprises receiving, from a second device, information indicative of availability of one or more candidate beams for a subsequent transmission after an initial transmission of a small data transmission procedure; and determining, based on the information, a set of target resources the subsequent transmission. With the solution of the present disclosure, the network may not need to monitor all the beams configured to the UE after the successful reception of the initial CG-SDT transmission, which may simplify the implements of the network and therefore improve the system performance. Meanwhile, the resources configured for multiple beams, which has been released or suspended by a UE, can be used for other UEs to increase resource efficiency given that likely the initial serving beam may remain the strongest throughout the entire SDT procedure.

### FIELD

Embodiments of the present disclosure generally relate to the field of telecommunication and in particular to devices, methods, apparatuses and computer readable storage media of configured grant (CG) resource handling for Small Data Transmission (SDT).

### BACKGROUND

The 3rd Generation Partnership Project (3GPP) has discussed the New Radio (NR) SDT inactive state in release 17. The main motivation for the discussion is to avoid the signalling overhead and delay associated with transition from RRC_INACTIVE to RRC_CONNECTED to perform the SDT.

It has been agreed that different types of SDT can be supported, such as 4-step Radom Access Channel (RACH) based SDT, 2-step RACH based SDT and Configured Grant (CG) based SDT.

### SUMMARY

In general, example embodiments of the present disclosure provide a solution of CG resource handling for SDT.

In a first aspect, there is provided a first device. The first device comprises at least one processor; and at least one memory including computer program codes; the at least one memory and the computer program codes are configured to, with the at least one processor, cause the first device at least to receive, from a second device, information indicative of availability of one or more candidate beams for a subsequent transmission after an initial transmission of a small data transmission procedure; and determine, based on the information, a set of target resources for the subsequent transmission.

In a second aspect, there is provided a second device. The second device comprises at least one processor; and at least one memory including computer program codes; the at least one memory and the computer program codes are configured to, with the at least one processor, cause the second device at least to transmit information to a first device, wherein the information is indicative of availability of one or more candidate beams to be used by the first device to perform a subsequent transmission after an initial transmission of a small data transmission procedure between the first device and the second device.

In a third aspect, there is provided a method. The method comprises receiving, from a second device, information indicative of availability of one or more candidate beams for a subsequent transmission after an initial transmission of a small data transmission procedure; and determining, based on the information, a set of target resources the subsequent transmission.

In a fourth aspect, there is provided a method. The method comprises transmitting information to a first device, wherein the information is indicative of availability of one or more candidate beams to be used by the first device to perform a subsequent transmission after an initial transmission of a small data transmission procedure between the first device and the second device.

In a fifth aspect, there is provided an apparatus comprising means for receiving, from a second device, information indicative of availability of one or more candidate beams for a subsequent transmission after an initial transmission of a small data transmission procedure; and means for determining, based on the information, a set of target resources the subsequent transmission.

In a sixth aspect, there is provided an apparatus comprising means for transmitting information to a first device, wherein the information is indicative of availability of one or more candidate beams to be used by the first device to perform a subsequent transmission after an initial transmission of a small data transmission procedure between the first device and the second device.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of CG resource handling for SDT according to some example embodiments of the present disclosure;

FIG. 3 shows a flowchart of an example method of CG resource handling for SDT according to some example embodiments of the present disclosure;

FIG. 4 shows a flowchart of an example method of CG resource handling for SDT according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements. These elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols. and/or any other protocols cither currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

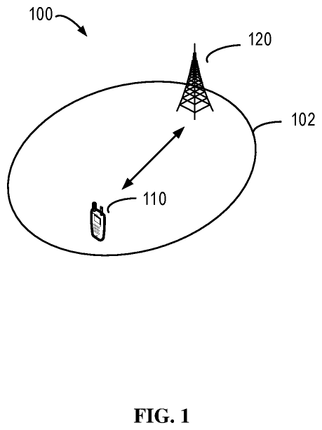

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120 (hereinafter may also be referred to as a gNB 120 or a second device 120). The network device 120 can manage a cell 102. The terminal device 110 and the network device 120 can communicate with each other in the coverage of the cell 102.

It is to be understood that the number of network devices and terminal devices shown in FIG. 1 is given for the purpose of illustration without suggesting any limitations. The communication network 100 may include any suitable number of network devices and terminal devices.

As discussed above, SDT in RRC inactive state has been discussed for signalling saving. Different types of SDT can be supported, such as 4-step RACH based SDT, 2-step RACH based SDT and CG based SDT.

It has been agreed that multiple Synchronization Signal and PBCH blocks (SSBs) could be mapped to CG Physical Uplink Shared Channel (CG PUSCH) resource. For example, the SSB-to-PUSCH resource mapping within the CG configuration can be implicitly defined.

Multiple SSBs may be configured for a CG configuration in TDM manner for CG-SDT transmission of a UE which may increase the possibility that the CG-SDT based transmission can still be used after the UE has moved under a different beam than the last serving beam while in inactive mode. The UE may select one SSB whose Synchronization Signal (SS) Reference Signal Received Power (SS-RSRP) is above a network-defined threshold upon initiation of SDT procedure if the CG-SDT criteria are met and perform the initial CG-PUSCH based SDT transmission using the selected SSB. Based on the reception of such UL transmission, the network may schedule the UE (e.g. DL data and/or RRC release message to terminate the SDT procedure) via the corresponding beam accordingly.

In a case where the UE changes to a better beam for a subsequent CG-SDT transmission rather than using the same beam used for an initial/a previous CG-SDT transmission, the new beam can be selected among any SSB beam(s) configured with CG PUSCH resources for SDT. The conditions for the beam changing/switching may need to be discussed.

Furthermore, when the UE is allowed to change the beam used for subsequent CG transmissions, the CG resources are not optimally utilized, because the CG resources mapped to the beam(s) other than the serving beam the UE, which is selected upon initiation of the SDT transmission, cannot be used for other UEs. Although the UE might switch to other beams, the UE may most likely stay on the same beam that it has selected initially by considering the relative short period for the SDT procedure.

The solution of the present disclosure proposes a mechanism for CG handling for CG-SDT. In this solution, the UE may receive, from a gNB, information indicative of availability of one or more candidate beams for a subsequent transmission after an initial transmission of a small data transmission procedure and determine a set of target resources for the subsequent transmission based on the information.

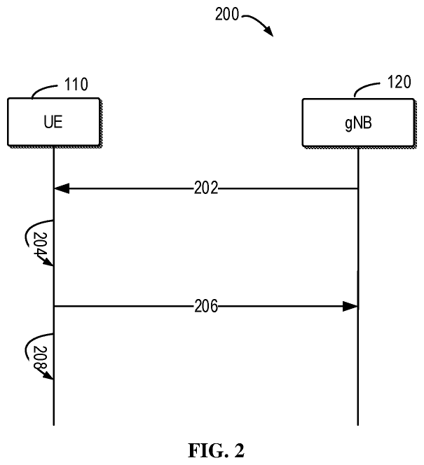

Principle and implementations of the present disclosure will be described in detail below with reference to FIG. 2, which shows a signaling chart illustrating a process 200 of CG resource handling for SDT according to some example embodiments of the present disclosure. For the purpose of discussion, the process 200 will be described with reference to FIG. 1. The process 200 may involve the UE 110 and the gNB 120.

Now the reference is made to FIG. 2. As shown, at step 202, the gNB 120 may transmit, to the UE 110 information indicative of availability of one or more candidate beams for a subsequent transmission.

It is to be understood that the subsequent transmission may refer to any subsequent transmission after the initial transmission in a SDT procedure has been successfully completed. It is also possible that the subsequent transmission may also refer to a retransmission of the initial transmission.

The information may indicate whether to allow UE to perform an autonomous beam switching. The information may also indicate a range within which the UE autonomous beam switching is allowed.

In some example embodiments, the information may indicate one or more candidate beams available for the first device to perform the subsequent transmission. That is, according to the information, the UE 110 may perform the subsequent transmission on a beam which is same with or different from an initial beam used for the initial transmission.

As described above, the gNB 120 may allocate multiple CG resources/occasions mapped to the set of candidate beams for the SDT procedure. By selecting the corresponding beam from the set of candidate beams, the UE 110 may determine the one or more CG resources for the transmission(s) in the SDT procedure. For example, the information may indicate one or more candidate beams available for the subsequent transmission, which may be considered as a subset of the set of candidate beams associated with the SDT procedure. Therefore, the CG resources mapped to the rest candidate beams other than the subset of candidate beams may be released or suspended by the UE 110. The released or suspended CG resources may be used by other UEs.

It is possible that information may indicate that only the CG resources corresponding to (for example, mapped to) the initial beam associated with the initial transmission can be used for the subsequent transmission. In this case, a UE autonomous beam switching may not be allowed at the UE 110 when the subsequent transmission is to be performed by the UE 110.

It is to be understood that CG resources mapped to the initial beam associated with the initial transmission may comprise one and more candidate resource for the initial transmission. It is also possible that the CG resources mapped to the initial beam associated with the initial transmission may also involve one and more additional candidate resource other than the one and more candidate resource.

In some example embodiments, the information may also indicate a set of CG resources corresponding to (for example, mapped to) the one or more candidate beams designated for the subsequent transmission. The one or more candidate beams may be associated to the initial beam. That is, if the UE 110 uses the initial beam for the initiation beam, the UE 110 may switch to the one or more candidate beams associated to the initial beam when the subsequent transmission is to be performed by the UE 110.

In some example embodiments, the information can be transmitted from the gNB 120 to the UE 110 before the SDT procedure, for example, along with the CG configuration for the SDT procedure. The information may also be transmitted from the gNB 120 to the UE 110 during the ongoing SDT procedure. It is also possible that the information may also be transmitted from the gNB 120 to the UE 110 in other suitable time period. For example, the information may be considered as the predefined or pre-configured information.

In some example embodiments, the information can be transmitted via different types of signalling, for example, a Physical (PHY) layer signalling, a Medium Access Control (MAC) signalling, or a Radio Resource Control (RRC) signalling.

Based on the information, as shown in FIG. 2, at step 204, the UE 110 may determine a set of target resources for the subsequent transmission.

For example, if the information indicates a set of candidate beams available for the subsequent transmission, the UE 110 may determine the set of target resources for the subsequent transmission from candidate CG resources which are mapped to set of candidate beams indicated in the information.

Alternatively, if the information indicates that only one or more CG resources mapped to the initial beam associated with initial transmission are available for the subsequent transmission, the UE 110 may determine the set of target resources for the subsequent transmission from the one or more CG resources mapped to the initial beam.

If the information indicates a set of candidate resources mapped to the one or more candidate beams that are designated for the subsequent transmission, the UE 110 may determine the set of target resources for the subsequent transmission from the set of candidate resources. For example, after selecting an initial beam, the UE 110 may use one or more of CG resources associated to the initial beam during subsequent transmissions in the SDT procedure. For example, these CG resources can have more CG occasions in the time domain compared to the CG resources assigned for initial transmissions.

In some example embodiments, the set of candidate beams or the set of candidate resources indicated in the information may be used only when certain condition(s) can be met.

For example, the UE 110 may determine a set of target resources for the subsequent transmission based on the information only if a response for the initial transmission is received from the gNB 120.

If the initial transmission fails, for example, there is no response within a certain time window, the UE may re-attempt/retry/retransmit the initial transmission by using at least one candidate beam associated with the SDT procedure which has a received power level (for example the RSRP) exceeding a threshold level or having an offset better than the previous selected beam. Otherwise, the re-attempt/retry/retransmission may stick to the initial beam.

It is also possible that the UE 110 may determine a set of target resources for the subsequent transmission based on the information when a number of reattempts on the initial beam for the initial transmission reaches a threshold number. The reattempt may be referred to any retransmission associated with the initial transmission, such as a Hybrid Automatic Repeat Request (HARQ) procedure.

After determining the set of target resources for the subsequent transmission, at step 206, the UE 110 may perform the subsequence transmission from the UE 110 to the gNB 120 by using the determined set of target resources.

After determining the set of target resources for the subsequent transmission, at step 208, the UE 110 may release or suspend other CG resources allocated for the SDT procedure other than the determined set of target resources for the subsequent transmission.

After the current SDT procedure is terminated, the suspended CG resources can be reactivated so that the UE 110 may select among any of CG resources initial allocated for the SDT procedure for the next CG-SDT procedure.

It is also possible that the gNB 120 may indicate some other resources/beams, which are different from the resources/beams indicated in the information, for the subsequent transmission during the SDT procedure. The UE 110 uses the resource/beam as indicated by the gNB 120 to perform the subsequent transmission. The target resource/beams availably for the UE 110 autonomous selection may be updated accordingly after the serving beam is changed by the gNB 120.

With the solution of the present disclosure, the network may not need to monitor all the beams configured to the UE after the successful reception of the initial CG-SDT transmission, which may simplify the implements of the network and therefore improve the system performance. Meanwhile, the resources configured for multiple beams, which has been released or suspended by a UE, can be used for other UEs to increase resource efficiency given that likely the initial serving beam may remain the strongest throughout the entire SDT procedure.

In this way, both network based and UE based beam management for SDT may still be supported without extra signaling and configuration. Furthermore, the solution of the present disclosure may allow the network to focus on beam configuration based on the CG configuration, i.e., beams in special domain close to each other could be configured in the same CG configuration so that the other configuration can be released/suspended upon the SDT.

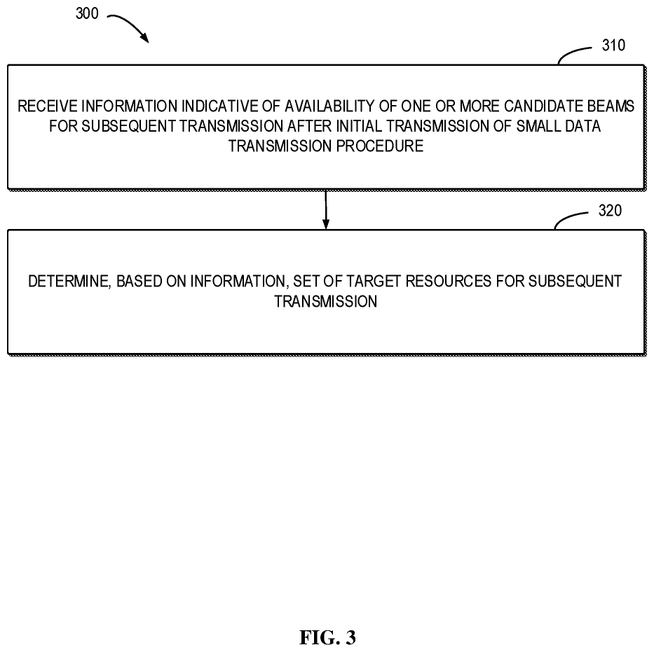

FIG. 3 shows a flowchart of an example method 300 of CG resource handling for SDT according to some example embodiments of the present disclosure. The method 300 can be implemented at the first device 110 as shown in FIG. 1. For the purpose of discussion, the method 300 will be described with reference to FIG. 1.

At 310, the first device receives, from a second device, information indicative of availability of one or more candidate beams for a subsequent transmission after an initial transmission of a small data transmission procedure.

In some example embodiments, the first device may receive the information before or during the small data transmission procedure.

In some example embodiments, the first device may receive the information via one of a PHY layer signalling, a MAC layer signalling and a RRC signalling.

At 320, the first device determines a set of target resources for the subsequent transmission based on the information.

In some example embodiments, if the first device determines, based on information, that the one or more candidate beams are available for the subsequent transmission, the first device may determine the set of target resources from candidate resources, the candidate resources being corresponding to the one or more candidate beams.

In some example embodiments, if the first device determines, based on information, that resources corresponding to an initial beam associated with the initial transmission are available for the subsequent transmission, the first device may determine the set of target resources from the resources.

In some example embodiments, the resources corresponding to an initial beam associated with the initial transmission may comprise at least one of: a first set of resources available for the initial transmission; and a second set of resources different from the first set of resources.

In some example embodiments, if the first device determines, based on information, that a set of candidate resources corresponding to one or more candidate beams are designated for the subsequent transmission, the first device may determine the set of target resources from the set of candidate resources.

In some example embodiments, the first device may determine the set of target resources for the subsequent transmission after a reception of a response to the initial transmission from the second device.

In some example embodiments, the first device may determine the set of target resources for the subsequent transmission after a number of reattempts on an initial beam for the initial transmission reaches a threshold number.

In some example embodiments, if the first device determines the initial transmission fails, the first device may reattempt the initial transmission by using at least one candidate beam associated with the small data transmission procedure, the at least one candidate beam having a received power level exceeding a threshold level.

In some example embodiments, the first device may release resources allocated for the small data transmission procedure other than the set of target resources for the subsequent transmission.

In some example embodiments, the first device may suspend resources allocated for the small data transmission procedure other than the set of target resources for the subsequent transmission.

In some example embodiments, the first device may reactivate, after an termination of the small data transmission procedure, the resources allocated for the small data transmission procedure that have been suspended for the subsequent transmission.

In some example embodiments, the first device comprises a terminal device and the second device comprises a network device.

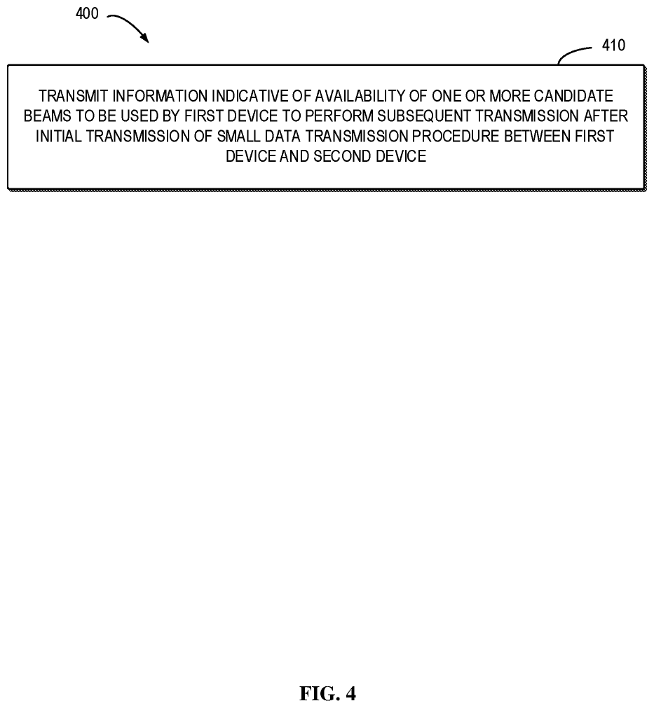

FIG. 4 shows a flowchart of an example method 400 of CG resource handling for SDT according to some example embodiments of the present disclosure. The method 400 can be implemented at the second device 120 as shown in FIG. 1. For the purpose of discussion, the method 400 will be described with reference to FIG. 1.

At 410, the second device transmit information to the first device, wherein the information is indicative of availability of one or more candidate beams to be used by the first device to perform a subsequent transmission after an initial transmission of a small data transmission procedure between the first device and the second device.

In some example embodiments, the second device may transmit the information to the first device before or during the small data transmission procedure.

In some example embodiments, the second device may transmit the information to the first device via one of a PHY layer signalling, a MAC layer signalling and a RRC signalling.

In some example embodiments, the first device comprises a terminal device and the second device comprises a network device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for receiving, from a second device, information indicative of availability of one or more candidate beams for a subsequent transmission after an initial transmission of a small data transmission procedure; and means for determining, based on the information, a set of target resources the subsequent transmission.

In some example embodiments, an apparatus capable of performing the method 400 (for example, implemented at the gNB 120) may comprise means for performing the respective steps of the method 400. The means may be implemented in any suitable form. For example, the means may be implemented in a circuitry or software module.

In some example embodiments, the apparatus comprises means for transmitting information to a first device, wherein the information is indicative of availability of one or more candidate beams to be used by the first device to perform a subsequent transmission after an initial transmission of a small data transmission procedure between the first device and the second device.

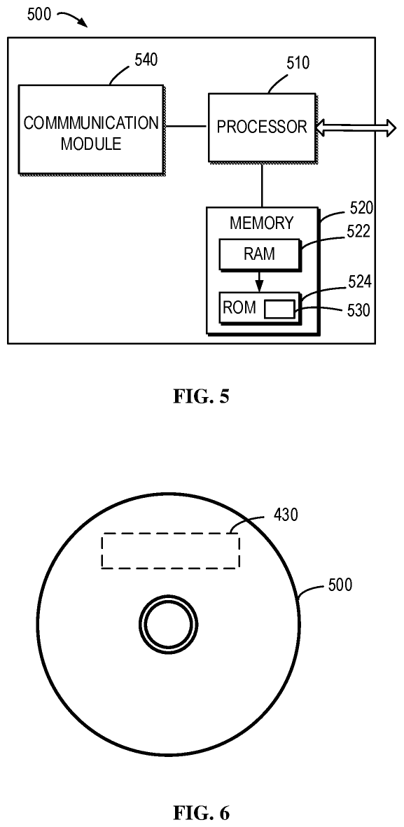

FIG. 5 is a simplified block diagram of a device 500 that is suitable for implementing embodiments of the present disclosure. The device 500 may be provided to implement the communication device, for example the UE 110 as shown in FIG. 1. As shown, the device 500 includes one or more processors 510, one or more memories 520 coupled to the processor 510, and communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital reference signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 522.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

In some embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300 and 400 as described above with reference to FIGS. 3-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a reference signal, computer readable medium, and the like.

The computer readable medium may be a computer readable reference signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program codes;
the at least one memory and the computer program codes are configured to, with the at least one processor, cause the first device at least to:
receive, from a second device, information indicative of availability of one or more candidate beams for a subsequent transmission after an initial transmission of a small data transmission procedure; and
determine a set of target resources for the subsequent transmission based on the information.

2. The first device of claim 1, wherein the first device is caused to determine the set of target resources by:
in accordance with a determination, based on the information, that the one or more candidate beams are available for the subsequent transmission, determining the set of target resources from candidate resources corresponding to the one or more candidate beams.

3. The first device of claim 1, wherein the first device is caused to determine the set of target resources by:
in accordance with a determination, based on the information, that resources corresponding to an initial beam associated with the initial transmission are available for the subsequent transmission, determining the set of target resources from the resources.

4. The first device of claim 3, wherein the resources corresponding to the initial beam associated with the initial transmission comprises at least one of:
a first set of resources available for the initial transmission; and
a second set of resources different from the first set of resources.

5. The first device of claim 1, wherein the first device is caused to determine the set of target resources by:
in accordance with a determination, based on the information, that a set of candidate resources corresponding to the one or more candidate beams are designated for the subsequent transmission, determining the set of target resources from the set of candidate resources.

6. The first device of claim 1, wherein the first device is caused to. determine the set of target resources for the subsequent transmission after a reception of a response to the initial transmission from the second device.

7. The first device of claim 1, wherein the first device is caused to determine the set of target resources for the subsequent transmission after a number of reattempts on an initial beam for the initial transmission reaches a threshold number.

8. The first device of claim 1, wherein the first device is further caused to:
in accordance with a determination that the initial transmission fails, reattempt the initial transmission by using at least one candidate beam associated with the small data transmission procedure, the at least one candidate beam having a received power level exceeding a threshold level.

9. The first device of claim 1, wherein the first device is further caused to:
release resources allocated for the small data transmission procedure other than the set of target resources for the subsequent transmission.

10. The first device of claim 1, wherein the first device is further caused to:
suspend resources allocated for the small data transmission procedure other than the set of target resources for the subsequent transmission.

11. The first device of claim 10, wherein the first device is further caused to:
reactivate, after a termination of the small data transmission procedure, the resources allocated for small data transmission procedure that have been suspended.

12. The first device of claim 1, wherein the first device is caused to receive the information before or during the small data transmission procedure.

13. The first device of claim 1, wherein the first device is caused to receive the information via one of:
a physical layer signaling,
a media access control layer signaling, and
a radio resource control signaling.

14. The first device of claim 1, wherein the first device comprises a terminal device and the second device comprises a network device.

15. A second device comprising:
at least one processor; and
at least one memory including computer program codes;
the at least one memory and the computer program codes are configured to, with the at least one processor, cause the second device at least to:
transmit information to a first device, wherein the information is indicative of availability of one or more candidate beams to be used by the first device to perform a subsequent transmission after an initial transmission of a small data transmission procedure between the first device and the second device.

16. The second device of claim 15, wherein the second device is caused to transmit the information to the first device before or during the small data transmission procedure.

17. The second device of claim 15, wherein the second device is caused to transmit the information to the first device via one of:
a physical layer signaling,
a media access control layer signaling, and
a radio resource control signaling.

18. The second device of claim 15, wherein the first device comprises a terminal device and the second device comprises a network device.

19. A method comprising:
receiving, from a second device, information indicative of availability of one or more candidate beams for a subsequent transmission after an initial transmission of a small data transmission procedure; and
determining a set of target resources available for the subsequent transmission based on the information.

20. The method of claim 19, wherein determining the set of target resources comprises:
in accordance with a determination, based on the information, that the one or more candidate beams are available for the subsequent transmission, determining the set of target resources from candidate resources, the candidate resources corresponding to the one or more candidate beams.

21.-40. (canceled)
